(19) United States
(12) Patent Application Publication
(10) Pub. No.: US 2015/0056520 A1
(43) Pub. Date: Feb. 26, 2015

(54) IMPREGNATED SINTERED SOLID STATE COMPOSITE ELECTRODE, SOLID STATE BATTERY, AND METHODS OF PREPARATION

(71) Applicant: Johnson IP Holding, LLC, Atlanta, GA (US)

(72) Inventors: Joykumar S. Thokchom, Atlanta, GA (US); Davorin Babic, Marietta, GA (US); Lonnie G. Johnson, Atlanta, GA (US); Lazbourne Alanzo Allie, McDonough, GA (US); David Ketema Johnson, Smyrna, GA (US); William Rauch, Douglasville, GA (US)

(21) Appl. No.: 14/382,191

(22) PCT Filed: Mar. 1, 2013
(86) PCT No.: PCT/US2013/028633

§ 371 Date: Aug. 29, 2014

Related U.S. Application Data
(60) Provisional application No. 61/605,236, filed on Mar. 1, 2012.

(51) Int. Cl. H01M 4/1391; H01M 4/139; H01M 10/052; H01M 4/13; H01M 10/0562

(52) U.S. Cl. CPC H01M 4/1391; H01M 4/13; H01M 10/0562; H01M 10/052; H01M 4/139; H01M 2300/0071
USPC 429/322; 429/209; 429/246; 264/620

(57) ABSTRACT

An impregnated solid state composite cathode is provided. The cathode contains a sintered porous active material, in which pores of the porous material are impregnated with an inorganic ionically conductive amorphous solid electrolyte. A method for producing the impregnated solid state composite cathode involves forming a pellet containing an active intercalation cathode material; sintering the pellet to form a sintered porous cathode pellet; impregnating pores of the sintered porous cathode pellet with a liquid precursor of an inorganic amorphous ionically conductive solid electrolyte; and curing the impregnated pellet to yield the composite cathode.

### CROSS-REFERENCE TO RELATED APPLICATION

This application is a Section 371 U.S. National-Stage Application of International Application No. PCT/US2013/028633, filed Mar. 1, 2013, which was published on Sep. 6, 2013, under International Publication No. WO 2013/130983, and which derives priority from U.S. Patent Application No. 61/605,236, filed Mar. 1, 2012, the disclosures of both of which are incorporated herein by reference in their entireties.

### BACKGROUND OF THE INVENTION

Solid-state lithium batteries have recently garnered a great deal of attention due to their many advantages over batteries that use liquid electrolytes. Safety is a major issue with liquid electrolyte batteries and constrains the use of batteries in some applications, such as the car industry. Benefits of solid-state batteries include improved safety and longer life because they do not contain any combustible organics and can operate at high temperatures, if needed.

Some of the major drawbacks in solid-state battery development have included achieving high energy density and capacity, which are inhibited by factors such as thickness of the cathode, the percentage of the cathode that can be accessed during discharge, and the rate at which the cathode can be accessed. The percentage of the cathode that can be accessed during charge/discharge is limited because lithium atoms generally have low diffusion coefficients in active intercalation cathode materials, so that lithium ions can only move a very limited distance from their entrance point into the intercalation material during a given period of time. In order to access the full capacity of a thick cathode at reasonable charge and discharge rates, the cathode must be rich in lithium ion conducting pathways that are connected and stretch throughout the body of the cathode. This goal is easily achievable using an organic liquid electrolyte which fills the pores of the cathode, providing the desired ionic pathways, but at a significant safety risk. The ability to replace the liquid electrolyte with a chemically stable and safe solid electrolyte, while maintaining the same high access of the liquid electrolyte battery, has been one of the main objectives of all solid state battery development.

Active cathode materials are generally oxides or oxide-based materials, such as transition metal oxides, phosphates and silicates. Large solid structures of these materials are usually prepared by sintering the corresponding powders. It would be expected that sintering an active cathode powder with a lithium ionically conductive solid electrolyte powder would form a high access cathode structure. However, it has been found that sintering a cathode material with a solid electrolyte normally induces solid-state reactions between the cathode and electrolyte, and may result in electrochemical deactivation of the interface.

Many attempts have been made to develop and commercialize solid-state lithium batteries with high access, capacity, and energy density. For example, Nagata and Nanno (Journal of Power Sources; 174; 832-837 (2007)) attempted to eliminate the solid-state reaction between cathode and electrolyte and the resulting deactivation of the interface by utilizing lithium aluminum titanium phosphate (LATP) as an electrolyte and lithium iron phosphate or lithium cobalt phosphate as an cathode active material. They were able to sinter the two materials without observing any significant additional new material phase at the interface between the cathode and electrolyte. However, in this method, the active cathode material was not sintered to itself to form excellent electrical conductivity because there were other LATP particles in the cathode. In addition, the final sintered structure was still very porous, and thus exhibited undesirably low density and low performance. Sintering of LATP powder with lithium cobalt oxide (LiCoO₂) powder was also reported, in which a new material phase was detected after the sintering, most likely making the interface electrochemically inactive. The resulting structures displayed very low performance as electrodes in electrochemical cells. It was concluded that a sintering process could be used to construct all solid state batteries, but only by selecting appropriately matched materials, not for general cathode/solid electrolyte material combinations.

Sun et al. (Journal of Power Sources; 196; 6507-6511 (2011)) report making an all solid lithium ion electrode by sintering at 950° C. lithium titanium oxide (LTO) as an active material component, lithium lanthanum titanium oxide (LLTO) as a Li ion conducting electrolyte component, and silver as an electronically conducting component. Both the active and the electrolyte materials were titanium oxides, thus representing a special matching materials case. In addition, the reported battery cycling results were only for a liquid electrolyte, not a solid electrolyte, thus preventing any real insight into the quality of the cathode for an all solid state battery. The LTO electrode has relatively low voltage and is frequently used and/or envisioned to be used as an anode in a battery, although its Li intercalation mechanism corresponds to a cathode.

Kotobuki et al. (Journal of the Electrochemical Society, 157 (4); A493-A498 (2010)) fabricated a sintered electrode by first forming a honeycomb structure of LLTO electrolyte, infiltrating the honeycomb pores with suspensions of lithium cobalt oxide and/or lithium manganese oxide particles, then sintering at ≧700° C. The produced battery cells were able to be cycled, but showed unacceptably high interface impedance of over 20 kOhm-cm².

Machida et al. (Journal of the Electrochemical Society, 149 (6) A688-A693 (2002)) also studied an all solid-state battery containing lithium cobalt nickel oxide as an active cathode material and an amorphous sulfide electrolyte. These cathode and electrolyte materials were milled and pressed into pellets along with acetylene black, i.e., no sintering was performed to compact the cathode and electrolyte material powders. A working battery of these materials was assembled by compacting and maintaining them under constant pressure of 300 MPa (3000 atm). The metallic fixture required to apply and maintain this high pressure severely reduces the volumetric and gravimetric capacities and energies of the battery, making it impractical.

Lee et al. (Journal of Ceramic Processing Research; Vol. 8, No. 2, pp. 106-109 (2007)) studied the production of lithium cobalt oxide (LiCoO₂) thick cathode films using screen-printing to produce an all solid-state micro-battery. Lee et al. mixed a sol gel precursor of LiCoO₂ with LiCoO₂ powder and then screen printed, achieving crack-free cathodes greater than 10 μm in thickness. However, for characterization purpose, the cell was analyzed using a liquid electrolyte for a lithium ion battery. It was concluded that even though liquid electrolyte was used for cycling and there were no signs of cracks due to cycle stress of the half cells tested, the cathode had good potential to form an all solid state battery. However, the sintered thick cathode described by Lee et al. consisted solely of lithium cobalt oxide, which is an active intercalation cathode material. No solid electrolyte (to provide ionically conductive pathways) was used in the battery cell fabrication or testing. Thus, the cell of Lee et al. was not an all solid state battery.

Other experimental work has focused on developing novel materials and structures for solid-state lithium cathodes, particularly with an emphasis on improving stability and structure. For example, Thackeray et al. (U.S. Patent Application Publication No. 2004/0081888 A1 and U.S. Pat. No. 7,732,096) describe stable cathode materials with various transition metal oxides.

Finally, Johnson et al. (U.S. Pat. Nos. 6,242,129 and 7,540,886) disclose methods of manufacturing thin film lithium batteries. The thin film lithium batteries have high charge/discharge rates and operate over a wide temperature range, but their energy density and specific energy are low, due to the unavoidable presence of an inactive but prohibitively large substrate. Johnson et al. (U.S. Patent Application Publication No. 2009/0092903) also disclose a solid state battery that consists of a sintered composite cathode and a sintered composite or Li metal anode. The sintered composite electrodes consist of an active intercalation material and a Li ion conducting solid electrolyte material.

The sintered electrodes described above, which exhibit favorable properties, also exhibit either higher interface resistance than desirable between the active intercalation material and the solid electrolyte material or belong to a specially matched pair of active and electrolyte materials (LTO and LLTO, as an example). Most of the high specific capacity active materials are oxides of cobalt, manganese, nickel and their combinations. However, because there are no known high Li ionically conductive solid electrolytes that are based on Co/Mn/Ni oxides, no matched active material/solid electrolyte pair exists. It is thus difficult to achieve high performance all solid state lithium ion batteries using sintering, and there remains a need in the art for improved, low cost, high access cathodes (and low voltage oxide electrodes such as LTO) for all solid state batteries.

### SUMMARY OF THE INVENTION

A method of producing an impregnated solid state composite cathode according to an embodiment of the invention comprises:
(a) forming at least one pellet comprising an active intercalation cathode material;
(b) sintering the at least one pellet to form at least one sintered porous cathode pellet;
(c) impregnating pores of the at least one sintered porous cathode pellet with a liquid precursor of an inorganic amorphous ionically conductive solid electrolyte; and
(d) curing the at least one impregnated pellet to yield the composite cathode.

An impregnated solid state composite cathode according to an embodiment of the invention comprises a sintered porous active intercalation material, wherein pores of the porous material are impregnated with an inorganic amorphous ionically conductive solid electrolyte.

An impregnated solid state composite electrode according to another embodiment of the invention comprises a sintered porous active material, wherein pores of the porous material are impregnated with an amorphous inorganic ionically conductive solid electrolyte.

A method of producing an impregnated solid state composite electrode according to another embodiment of the invention comprises:
(a) forming at least one pellet comprising an active electrode material;
(b) sintering the at least one pellet to form at least one sintered porous electrode pellet;
(c) impregnating pores of the at least one sintered porous electrode pellet with a liquid precursor of an inorganic amorphous ionically conductive solid electrolyte; and
(d) curing the at least one impregnated pellet to yield the composite electrode.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is an SEM image of the surface of a sintered porous cathode material according to an embodiment of the invention;

FIG. 2 is an SEM image of a cross section of a sintered porous cathode material according to an embodiment of the invention;

FIG. 3 is an SEM image of a cross section of a cathode filled with LLZO solid electrolyte according to an embodiment of the invention;

FIG. 4 is a Nyquist plot of a cured amorphous LLZO film prepared from a 25% condensed LLZO precursor solution;

FIG. 5 is a Nyquist plot of a cured amorphous LLZO film prepared from a 50% condensed LLZO precursor solution;

FIG. 6 is a Nyquist plot of a cured amorphous LLZO film prepared from a 75% condensed LLZO precursor solution;

FIG. 7 is a graph of ionic conductivity of amorphous LLZO films as a function of concentration level of their precursor solution; and

FIG. 8 is a Nyquist plot of a cured amorphous LLZO film prepared from a 75% LLZO condensed precursor solution condensed in ozone.

### DETAILED DESCRIPTION OF THE INVENTION

This invention is directed to a process for producing an impregnated, sintered composite cathode, such as for use in an all solid state battery, the cathode produced by the process, and a solid state battery containing the cathode. The process for producing the cathode involves four basic steps: preparing pellets from an active (intercalation) cathode material, sintering the pellets at high temperature to form a sintered porous cathode pellet structure, impregnating the pores with a liquid precursor of an inorganic amorphous ionically conductive solid electrolyte, and drying and curing the impregnated material to convert the precursor into an inorganic amorphous solid electrolyte and yield the composite cathode. Each of these process steps will be described in more detail below.

The hereby disclosed invention and process apply particularly to oxide electrodes in lithium and lithium ion batteries which are mostly applied as cathodes, although there are examples of oxide anodes, such as lithium titanium oxide (LTO). Thus, for the purposes of this disclosure, the term “cathode” may be understood to refer not only to a cathode per se, but also to any active oxide electrode, even if it is used as an anode in a battery due to its low voltage. Additionally, although lithium batteries contain an anode made of pure lithium and lithium ion batteries contain an anode made of lithium-containing material, the terms “lithium battery” and “lithium ion battery” are used interchangeably in this disclosure.

Pellets from Active Cathode Powder

The first step in the method for producing the composite cathode involves preparing pellets from an active (intercalation) cathode material, such as an active powder. For forming a cathode, the active cathode powder for use in the invention is preferably LiMn_{1/3}Ni_{1/3}Co_{1/3}O₂ (“NCM”), which is commercially available, such as from Pred Materials International (New York, N.Y.). Other oxide active intercalation material powders known in the art, such as LiCoO₂, or to be developed for use in lithium or lithium ion batteries would also be appropriate.

Active intercalation materials, particularly those used in cathodes of lithium or lithium ion batteries, are generally electronically conductive, including the preferred NCM and LiCoO₂. However, other oxide electrode materials may also be used to form a composite solid state electrode according to the invention. For example, LTO is an oxide intercalation material that is generally considered to be an anode material due to its low voltage. Because LTO is not electronically conductive, an electronically conductive material, such as silver, should be added to LTO to form the sintered composite structure. It is also within the scope of the invention to add silver (or another suitable electronically conductive material) to the active intercalation material prior to sintering, even if it is electronically conductive, to enhance the electronic conductivity of the composite all solid state structure.

To form the pellets, a slurry is first prepared by mixing the cathode powder with solvents, such as xylene and ethanol, binder(s), such as polyvinyl butyral (PVB), and/or plasticizer(s), such as butyl benzyl phthalate. A preferred mixture contains about 150 g of active cathode powder, about 30 g of xylene, about 30 g of ethanol, about 7 g of PVB, and about 3.5 g of butyl benzyl phthalate. Other solvent, binder and plasticizer materials may be used in different material proportions provided that they form a slurry whose properties, such as viscosity, are suitable for tape casting as described in “Tape Casting: Theory and Practice” (R. E. Mistler and E. R. Twiname (Wiley-ACS, 2000)), which is herein incorporated by reference.

The combination of powder, solvents, binder(s), and/or plasticizer(s) is mixed thoroughly, such as by ball milling, to form a homogeneous slurry, then cast into a sheet by tape casting on a standard flat casting table. The method of tape casting is well known in the art and need not be described. Appropriate conditions for the tape casting are known in the art or may be determined by routine experimentation.

The resulting sheet is then dried, such as for about two hours at room temperature, and rolled. In order to obtain uniformity and desired density, the sheet is folded and calendered (compacted), such as between rollers, to the desired thickness, preferably about 6 mil (150 microns), but generally in the approximate range of about 40 to 500 microns. The resulting uniform sheet is then punched into pellets of a desired size and heated to remove the organic components. For example, the sheet may be punched into pellets of about ¾″ diameter using a round puncher and heated at about 400° C. in air for about two hours in order to remove the organic components from the pellets. These pellet diameters and heating conditions are merely exemplary, and other pellet diameters, shapes, thicknesses, techniques for compacting the sheet, punching the pellets, and heating protocols to remove the organics are also within the scope of the invention. Additionally, it is also within the scope of the invention to prepare cathode shapes other than pellets, such as sheets, wafers, or other shapes, provided that such shapes will function as desired, such as in a battery. If the composite cathode is desired in sheet or wafer form, it is not necessary to punch pellets from the sheet as previously described. Rather, the whole sheet itself may be sintered, as described below, to form the cathode. Accordingly, the description herein of pellets may be understood to encompass other cathode shapes as well.

### Sintering of Pellets

The pellets prepared from the active cathode powder are next sintered at a high temperature of about 800-1100° C., preferably about 900° C., in either oxygen or air, for about ten minutes to about twelve hours, preferably about one hour, to produce a self supporting porous cathode pellet structure. The sintering process (time and temperature profiles) is controlled so that the resulting structure will have sufficient porosity to allow for impregnation with the electrolyte solution.

The sintered porous pellet structure has good cathode powder particle-to-particle contact because the particles merge during sintering. The cathode pellet also forms electronically conductive pathways because the active cathode materials are usually electronic conductors. If a particular oxide electrode material is not an electronic conductor (such as LTO), a suitable electronically conductive additive (silver, for example) may be added to the slurry to form the electronically conductive pathways in the sintered pellets.

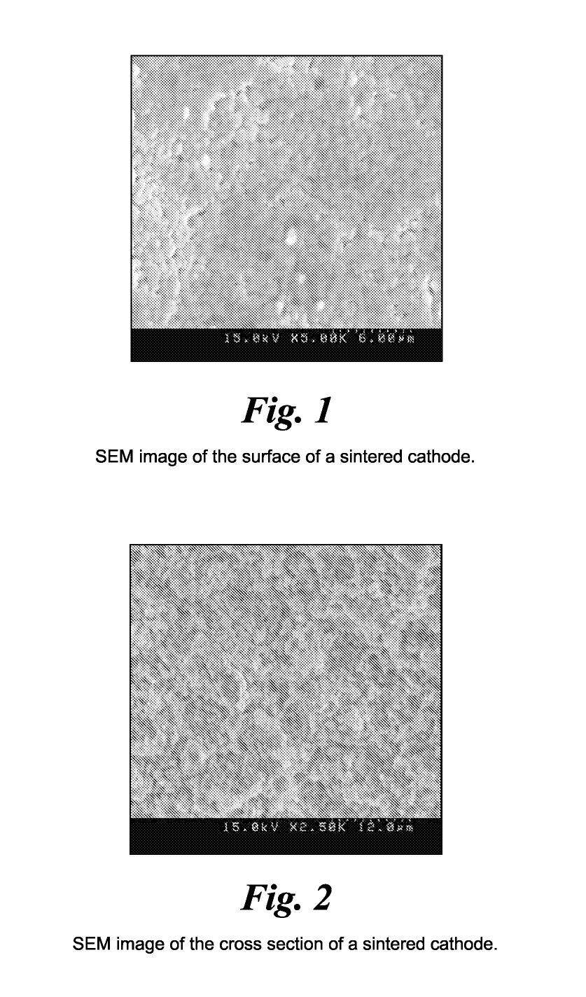

Another notable feature of the sintered cathode pellet is that it is very uniform due to the tape casting method and the calendering process. This uniformity provides a good structure to fill with electrolyte in the subsequent step and yield an excellent composite high access cathode. SEM images of the surface and cross section structure of an exemplary sintered cathode material are shown in FIGS. 1 and 2, respectively, which clearly show the uniformity of the porous structure. The typical density of the sintered cathode pellet without solid electrolyte is estimated from SEM images of its surface and cross section to be about 60%. However, the porosity may be greater or less than this amount and this density (porosity) is exemplary, not limiting.

### Impregnation of Porous Pellet Structure

For an all solid state lithium or lithium ion battery to have high access, capacity, and energy density, it must have effective pathways for the lithium ions and electrons to move throughout the body of the cathode during charge and discharge of the battery. As previously explained, the sintered porous pellets have effective electron pathways. In order to provide effective ionic pathways in the body of the cathode pellet of an all solid state battery, it is necessary to fill the pores of the pellet with a solid inorganic electrolyte.

Thus, the next step in the method involves filling the pores in the sintered pellet with a liquid precursor solution of an inorganic amorphous ionically conductive solid electrolyte to form ionic pathways. Preferred solid electrolytes for use in the invention are amorphous lithium lanthanum zirconium oxide (LLZO), lithium carbon lanthanum zirconium oxide (LCLZO), and lithium lanthanum titanium oxide (LLTO). LLZO and LCLZO are described in U.S. Patent Application Publications Nos. 2011/0053001 and 2012/0196189, the disclosures of which are herein incorporated by reference in their entirety. These application publications will hereinafter be referred to as “the '001 publication” and “the '189 publication,” respectively. For the purposes of this disclosure, the term “LLZO” may be understood to refer to LLZO and/or LCLZO. It is also within the scope of the invention to utilize alternative amorphous inorganic ionically conductive materials instead of or in addition to the LLZO. Other preferred materials are also amorphous, oxide-based compounds. For example, appropriate amorphous inorganic materials are those in which one or more of the elements in LLZO has been partially or completely replaced by a different element, such as replacing zirconium with tantalum. Such alternative materials are also described in the '001 and '189 application publications and all of the materials described therein are also within the scope of the invention.

The process of inserting an inorganic solid electrolyte into the pores of the sintered pellets begins by impregnating the cathode pores with an inorganic solid electrolyte precursor solution and then curing the solution to form the solid inorganic electrolyte. This process has its challenges. A main challenge is due to surface tension of the electrolyte precursor solution. The surface tension controls the wetting of the cathode surface by the precursor solution ,which is necessary to fully impregnate the cathode pores. It has been found that the surface tension of the preferred LLZO precursor solution is adequate for wetting the porous sintered cathode pores. Another challenge is due to high shrinkage of the electrolyte precursor when forming the solid inorganic electrolyte.

According to an embodiment of the invention, the pores of the sintered porous cathode are first evacuated to remove all of the air, such as, for example, with a small vacuum pump. The pores are then impregnated with a precursor solution for the inorganic solid amorphous electrolyte. For example, appropriate precursor solutions for LLZO and LCLZO are described in detail in U.S. Patent Application Publications Nos. 2011/0053001 and 2012/0196189. In a preferred embodiment, the solution contains a lanthanum alkoxide, a lithium alkoxide, and a zirconium alkoxide dissolved in a solvent, such as an alcohol. Preferred precursors include lithium butoxide, lanthanum methoxyethoxide, and zirconium butoxide, and a preferred solvent is methoxyethanol. These precursor components are exemplary, not limiting, and alternative precursor solutions are also within the scope of the invention, provided that they contain the required lithium, lanthanum, zirconium, and oxygen components in appropriate concentrations. It is also within the scope of the invention to prepare more than one solution, such as three solutions each containing one of the desired lithium, lanthanum, or zirconium components. If an amorphous material other than or in addition to LLZO/LCLZO is to be contained in the final cathode, the appropriate precursor solution(s) should contain the desired components in appropriate concentrations.

Appropriate precursor solutions for LLTO, another preferred electrolyte, are described in detail in U.S. Pat. No. 8,211,496, the disclosure of which is herein incorporated by reference in its entirety. These precursor solutions are exemplary, not limiting, and even the preferred LLZO and LCLZO may be applied from alternative precursor solutions, provided that they contain the required lithium, lanthanum, zirconium, and oxygen components in appropriate concentrations. Impregnation is preferably performed by casting the solution over the surface of the pellet, so that the solution impregnates the evacuated pores by capillary action.

It has been found that the preferred LLZO precursor solution, which is prepared from commercially available metal precursors, some of which (such as lanthanum methoxyethoxide and zirconium butoxide) are obtained in solution, exhibits high volume shrinkage of about 90% when cured to form an amorphous solid LLZO electrolyte. This high shrinkage is inconvenient because it requires many impregnation cycles of the pores with the precursor solution in order to reach an adequate level of pore filling, defined by formation of fast lithium ion conductive pathways through the amorphous solid electrolyte that is present in the pores. It has been found that a number of the impregnation steps may be eliminated by utilizing a condensed (concentrated) precursor solution (containing less solvent than the original precursor solution but the same amounts of the other components) that shrinks less during the curing process than the dilute solution. If the precursor solution for the solid electrolyte is prepared in more concentrated form, it is not necessary to perform such a condensation step.

Condensation of the precursor solution may be accomplished by heating a dilute precursor solution, such as the LLZO precursor solution previously described, in an inert environment, such as nitrogen or argon. A preferred heating temperature is about 80° C., although it may vary in a wide range from about room temperature to about 100° C.

High ionic conductivity of the amorphous electrolyte is necessary for its successful application in a lithium ion battery. The ionic conductivity of amorphous LLZO/LCLZO samples prepared from condensed precursor solutions having different condensation levels was measured in order to determine the optimal condensation level.

It was found that condensing the LLZO precursor solution in ozone maintains the high ionic conductivity, allowing for the use of a more concentrated solution to fill the pores of the cathode and reducing the number of impregnations necessary to achieve the desired ionic conductivity levels. Consequently, if the precursor solution is determined to be too dilute (resulting from the fact that the desired precursors are commercially obtained in solution), the precursor solution is preferably condensed prior to impregnation into the pores of the sintered cathode. If the LLZO precursor solution described previously is utilized, it is preferably condensed by about 25% to about 50%. However, it is preferred to prepare a more concentrated precursor solution so that the condensation process is not required, yet high conductivity and low shrinkage can still be achieved.

The SEM image of a cathode partially filled with solid LLZO electrolyte is shown in FIG.

3. It can be seen that the amorphous solid electrolyte partially fills the pores or coats the NCM sintered particles, based on the amorphous material seen in the image, forming continuous pathways for lithium ions. It is not necessary to completely fill the pores with solid electrolyte; the pores only need to be partially filled to establish the desired high conductivity.

### Curing the Electrolyte

The final step in the process of producing an impregnated sintered composite solid state cathode involves curing the liquid precursor solution of the inorganic amorphous solid electrolyte by drying and heating the impregnated pellets. For example, drying and heating may be effected by maintaining the samples in an ozone-rich and low humidity air environment for about one hour followed by heating at approximately 70 to 130° C., more preferably about 75 to 90° C., most preferably about 80° C. for about 30 minutes, preferably in an ozone-rich air and low humidity environment, followed by heating at approximately 280 to 350° C., more preferably about 300-310° C. for about 30 minutes in low-humidity air. The specific drying and heating times and temperatures may be varied, but are preferably performed at no higher than about 350° C. Importantly, the lower temperature curing is performed in an ozone-rich (preferably containing at least about 0.05 ppm ozone) and low humidity (preferably less than about 30 percent relative humidity) environment, and the higher temperature heating is performed in low humidity air. The resulting composite solid state cathode containing impregnated amorphous solid electrolyte may be used to form a solid state battery, but is not limited to this application.

As previously explained, the method for producing an impregnated sintered composite solid state cathode may also be used to produce any other electrode in which the active material operates by intercalation and can be sintered. For example, lithium titanium oxide (LTO) is an intercalation oxide that can be sintered, and the above described impregnation and curing steps may be used to form a functional electrode from a sintered LTO pellet. The LTO electrode is used as an anode in a battery due to its low voltage, although in every other way it is and behaves as a cathode.

### Composite Solid State Cathode

The invention is also directed to an impregnated sintered solid-state composite cathode, such as for an all solid state battery. The composite cathode contains a sintered active intercalation material having pores impregnated with an inorganic ionically conductive amorphous solid electrolyte. The active intercalation material is sintered in the form of a compact porous structure and is preferably in the form of sintered pellets prepared from an active cathode powder, as previously described. However, the invention is not limited to composite cathodes in the shape of pellets. Rather, it is also within the scope of the invention for the composite cathode to be the shape of a sheet, wafer, or any other shape, provided that it contains the desired components and will function as desired, such as in a battery.

Active intercalation materials, particularly those used in cathodes of lithium or lithium ion batteries, are generally electronically conductive. However, other oxide electrode materials may also be used to form a composite solid state electrode according to the invention. For example, LTO is an oxide intercalation material that is generally considered to be an anode material due to its low voltage. Because LTO is not electronically conductive, an electronically conductive material, such as silver, must be added to LTO to form the sintered structure. It is also within the scope of the invention to add silver (or another suitable electronically conductive material) to the active intercalation material even if it is electronically conductive to enhance the electronic conductivity of the composite all solid state structure.

The inorganic amorphous solid electrolyte in the solid state cathode is most preferably amorphous solid LLZO and/or LCLZO, as previously described. Preferably, the inorganic amorphous solid electrolyte is impregnated into the pores of the sintered cathode as a liquid precursor solution and then subjected to a thermal drying and curing process to convert the precursor solution into the amorphous solid electrolyte. Although LLZO and LCLZO are most preferred, it is also within the scope of the invention to utilize other inorganic ionically conductive materials, provided that they can be impregnated into the pores of the cathode as a liquid and then solidified after a relatively low temperature curing process. For example, a mixed electronic/ionic conductor, such as amorphous LLTO, may also be used to impregnate the electrode pores in another preferred embodiment. Other preferred amorphous inorganic materials are oxide-based materials. Further, other appropriate amorphous inorganic materials are those in which one or more of the elements in LLZO has been partially or completely replaced by a different element, such as replacing zirconium with tantalum. Such alternative materials are also described in the '001 and '189 application publications and all of the materials described therein are also within the scope of the invention.

As previously explained, the invention is also directed to other solid state composite electrodes, such as anodes, which have the same structure as described above with respect to the cathode. In particular, an LTO electrode having an impregnated sintered structure is also included in the invention.

The cathodes and low voltage oxide electrodes according to the invention thus fulfill a need in the art for improved, low cost, high access electrodes, which may be used in the production of all solid state batteries.

### Solid State Battery

Finally, the invention is directed to a solid state lithium or lithium ion battery comprising an impregnated sintered composite solid state cathode, an anode, and a separator, in which the composite solid state cathode is as described previously. The separator may be any solid electrolyte known in the art or to be developed, such as LiPON, crystalline LLZO, amorphous LLZO, etc. The anode may be any anode material known in the art or to be developed, such as lithium metal, alloys thereof, and LTO. Methods for depositing the solid electrolyte separator and anode materials on top of a solid cathode are well known in the art and need not be described. Methods for producing solid state batteries from cathode, anode, and separator components are also well known in the art and also need not be described.

Additionally, the invention is directed to a solid state lithium or lithium ion battery comprising an impregnated sintered composite solid state anode, a cathode, and a separator, in which the composite solid state anode is as described previously. In other words, a solid state lithium or lithium ion battery according to an embodiment of the invention comprises an impregnated sintered composite state electrode as described previously, a lithium-containing counter electrode, and a separator.

The invention addresses problems with prior art electrodes by providing a freestanding high-access cathode structure with thickness of 100 μm or greater, if desired. The invention also overcomes disadvantages of prior art electrodes with regard to low energy density and access of the cathode, thus improving capacity and rate capability of the resulting battery. Specifically, enhancing access of the cathode by providing ionic and electronic pathways for lithium ions and electrons to travel during the charge and discharge processes is achieved by filling the pores of a highly electronically conductive cathode with a highly ionically conductive material, such as amorphous LLZO. This is effectively achieved by concentrating an electrolyte precursor solution, such that shrinkage after curing is much less than a regular unconcentrated precursor solution of the material.

Another problem addressed by the present invention is that of solid-state reactions when sintering the cathode material and the solid electrolyte. This problem is resolved by first sintering the cathode to obtain excellent electronic conductivity, and then filling the pores of the sintered cathode with a liquid precursor solution of the amorphous solid electrolyte, which cures in the pores to form the solid amorphous electrolyte and the composite solid state structure. By this method, a safe solid state cathode having higher access, capacity and energy density compared to currently available cathodes is obtained. The invention also provides low voltage cathodes, such as LTO, which may be used as anodes in solid state batteries.

The current invention is thus an improvement on both liquid electrolyte and thin film batteries whereby a novel freestanding cathode, between about 50 and 400 μm thick, is fabricated with enhanced safety, access, capacity and energy density by a low-cost process.

This invention will now be described in connection with the following, non-limiting examples.

### EXAMPLE 1

### Preparation of Cathode Pellet

A slurry was prepared from 150 g of cathode powder (NCM), obtained from Pred Materials International (New York, N.Y.), about 30 g of xylene, about 30 g of ethanol, about 7 g of PVB, and about 3.5 g of butyl benzyl phthalate. The combination of powder, solvents, binder(s), and plasticizer(s) was mixed thoroughly by ball milling to form a homogeneous slurry, then cast into a sheet by tape casting on a standard flat casting table.

The resulting sheet was dried for about two hours at room temperature, folded, and calendered (compacted) between rollers using a roller-compactor apparatus to the desired thickness of about 6 mil (150 microns). The resulting uniform sheet was then punched into pellets of about ¾″ diameter using a round puncher and heated at about 400° C. in air for about two hours in order to remove the organic components from the pellets. The pellets were then sintered at 900° C. in oxygen for about one hour to produce a self supporting porous cathode pellet structure. SEM images of the sintered porous pellets are shown in FIGS. 1 and 2.

A LLZO sol gel precursor solution was prepared by dissolving about 9 grams of a lanthanum methoxyethoxide solution (about 12% by weight in methoxyethanol), about 1.3 grams of lithium butoxide and about 1.54 gram of a zirconium butoxide solution (about 80% by weight in butanol) in about 10 grams of methoxyethanol. The precursor components were obtained from either Gelest or Alfa Aesar. The thoroughly-mixed precursor solution was left in a bottle in an inert environment for about 1 to 1.5 hours to help facilitate substantially complete dissolution of the lithium butoxide. The solution was then condensed to 75% condensed precursor solution by heating at 80° C. for about 3 hours.

The pores of the sintered porous cathode were evacuated with a small vacuum pump to remove the air, then impregnated with the LLZO precursor solution by casting the solution over the surface of the pellets, so that the solution impregnated the evacuated pores by capillary action.

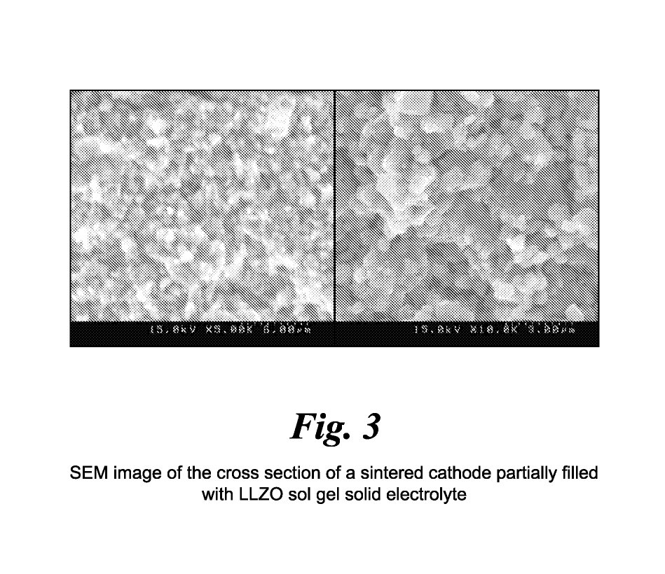

Finally, the precursor solution was dried and cured by maintaining the impregnated pellets in an ozone-rich (at least 0.05 ppm) and low humidity (less than about 30%) air environment for about 1 hour, heating at approximately 80° C. for about 30 minutes in an ozone-rich air and low humidity environment, followed by heating at approximately 300° C. for about 30 minutes in air. The SEM image of a cross section of an LLZO impregnated sintered pellet is shown in FIG. 3.

### EXAMPLE 2

### Comparison of Precursor Solution Concentration

Measurements were performed by spin coating differently condensed precursor solutions onto glass substrates with conductive aluminum strips. After curing of the spin-coated layers by the regular LLZO curing process, a second layer of gold contacts was sputtered on top.

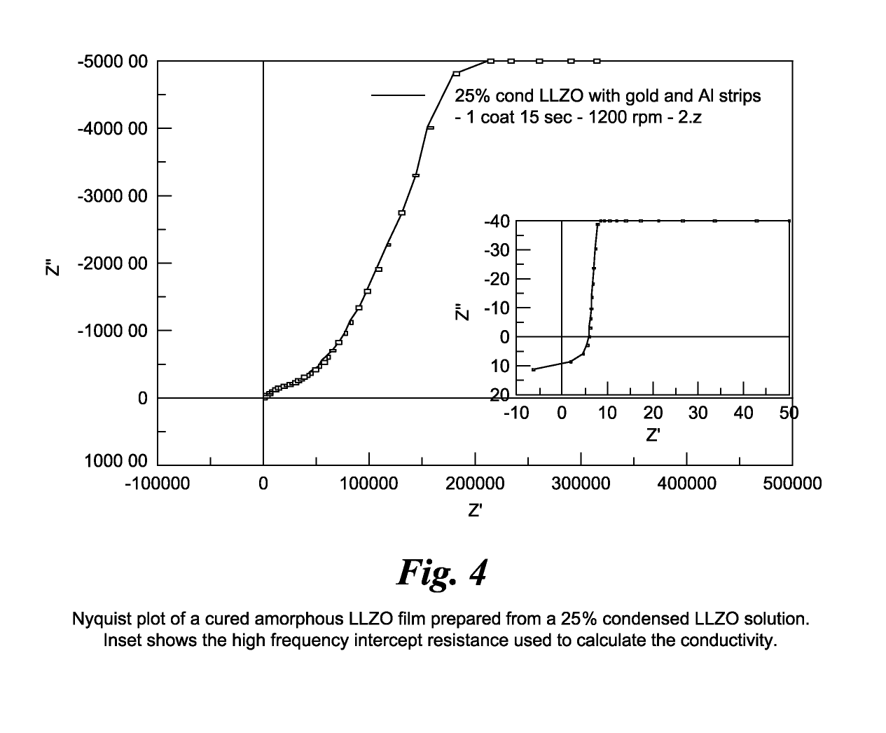

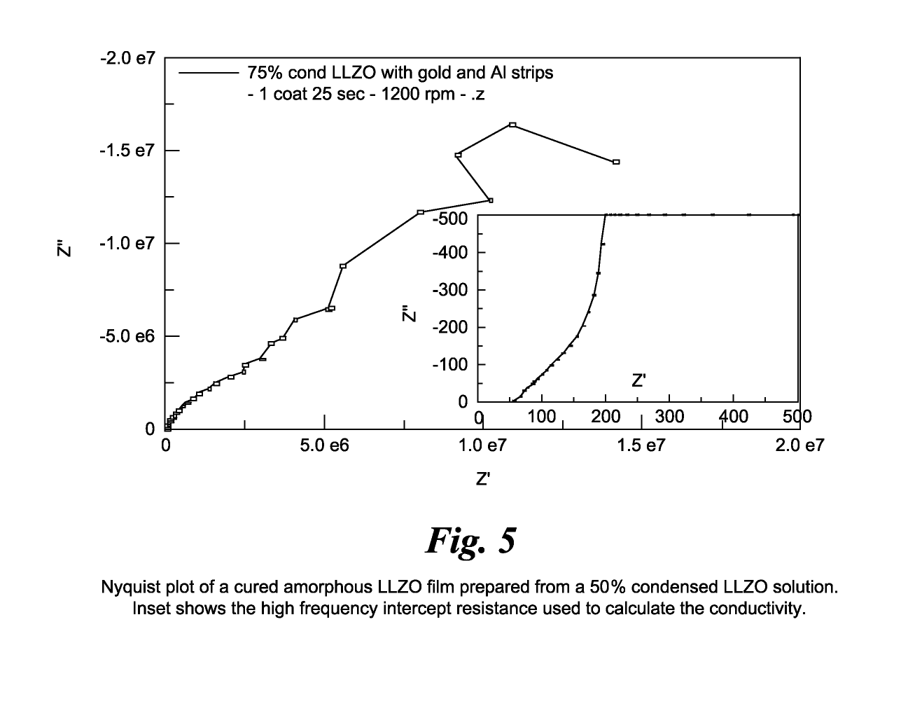

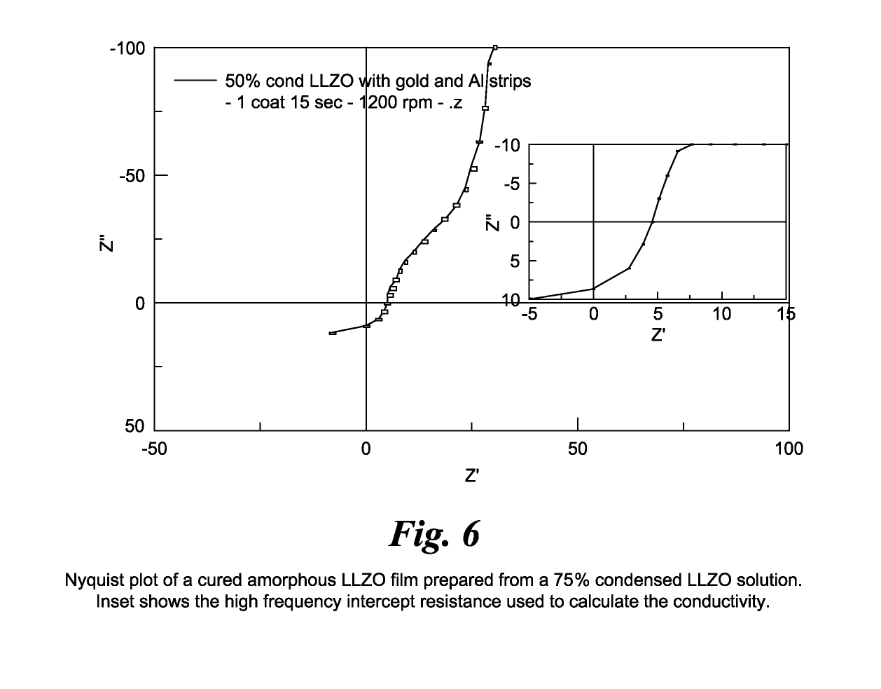

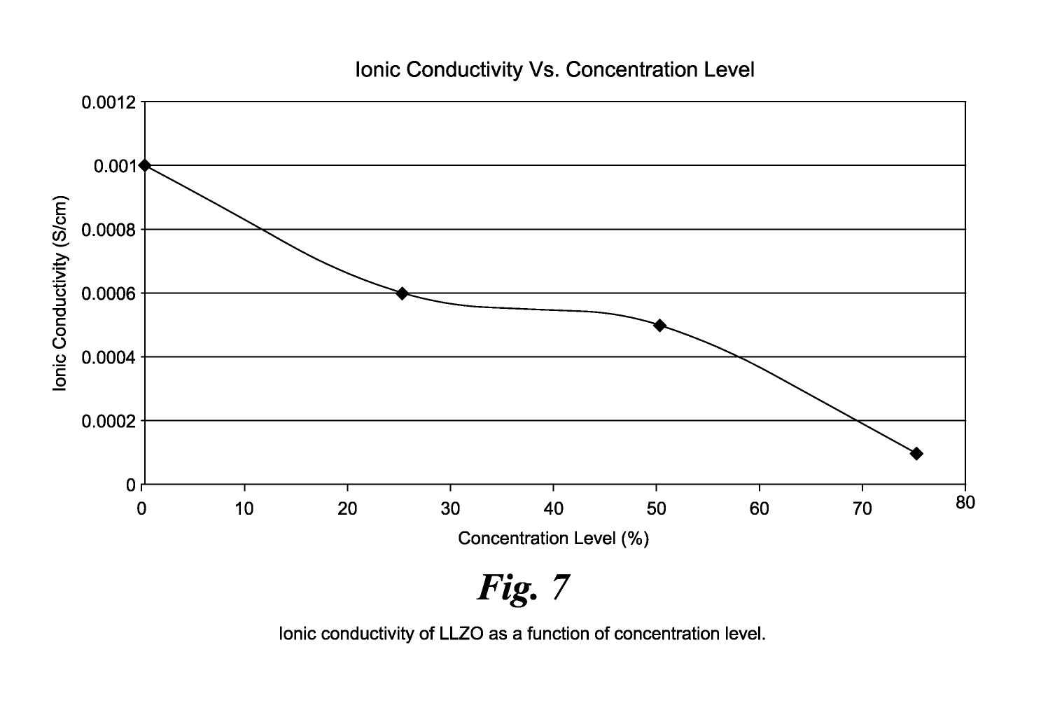

The impedance of the resulting amorphous LLZO films was measured using an electrochemical impedance spectroscopy (EIS) instrument. The EIS data for the amorphous LLZO films prepared from 25%, 50% and 75% condensed precursor solutions (75% represents the highest concentration) are shown in FIGS. 4, 5 and 6, respectively. The resistance used to calculate the conductivity of the LLZO films is taken at the high frequency real axis intercept of the Nyquist plot, which is more clearly shown in the inset of the graphs. Using this resistance and the thickness and the geometry of the sample, the conductivity may be estimated. FIG. 7 is a graph of the conductivity of the amorphous films for the three concentration levels of the precursor solutions as a function of concentration. It can be seen that the ionic conductivity decreases as the concentration level increases, although it did not change drastically from the 25% to the 50% condensed solution (6E-4 S/cm vs. 5E-4 S/cm). The conductivities of the 25% and 50% condensed solutions are both adequate for use in all solid state lithium batteries.

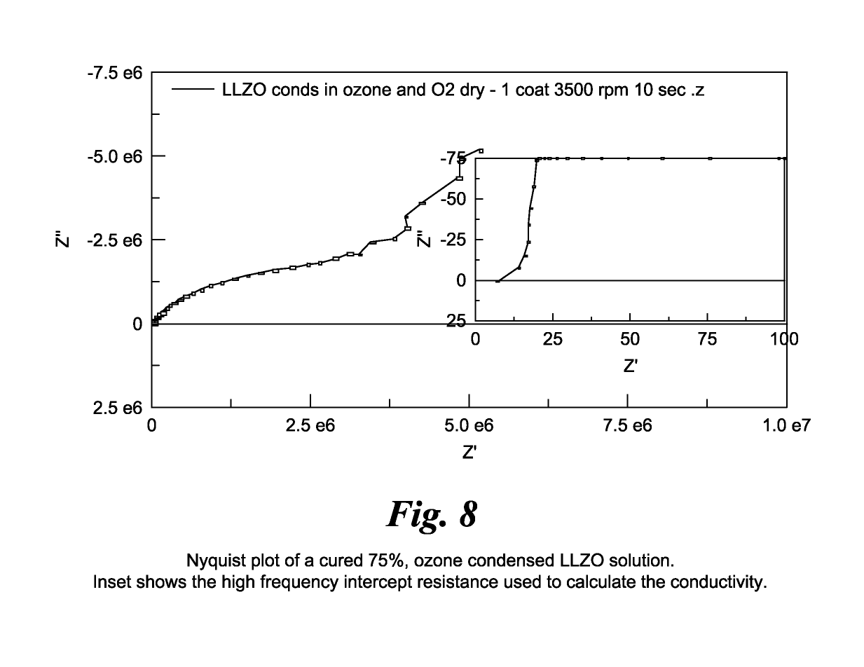

As described in U.S. Patent Application Publication No. 2011/0053001, the amorphous solid LLZO drying and gelling environment is controlled by relative humidity, ambient temperature, and ozone level. Accordingly, the influence of ozone on the LLZO precursor solution condensation process was tested to ensure mutual compatibility. FIG. 8 shows the Nyquist plot for an amorphous LLZO film prepared from a 75% condensed precursor solution that was condensed in an ozone rich environment (at least 0.05 ppm).

It was found that the ionic conductivity of this amorphous LLZO material was 5.9E-4 S/cm, which is essentially the same as for the film prepared from the 25% condensed solution.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of producing an impregnated solid state composite cathode, comprising:
(a) forming at least one pellet comprising an active intercalation cathode material;
(b) sintering the at least one pellet to form at least one sintered porous cathode pellet;
(c) impregnating pores of the at least one sintered porous cathode pellet with a liquid precursor of an inorganic amorphous ionically conductive solid electrolyte; and
(d) curing the at least one impregnated pellet to yield the composite cathode.

2. The method according to claim 1, wherein step (a) comprises:
(i) forming a slurry comprising an active intercalation cathode powder and at least one component selected from the group consisting of a solvent, a plasticizer, and a binder;
(ii) casting the slurry to form a sheet; and
(iii) forming at least one pellet from the sheet.

3. The method according to claim 2, further comprising drying the sheet prior to step (iii).

4. The method according to claim 2, further comprising compacting the sheet prior to step (iii).

5. The method according to claim 2, wherein the sheet has a thickness of about 40 to 500 microns.

6. The method according to claim 2, wherein the slurry further comprises an electronically conductive additive.

7. The method according to claim 1, wherein step (b) is performed at about 800°-1100° C.

8. The method according to claim 1, wherein the inorganic amorphous ionically conductive solid electrolyte comprises at least one material selected from the group consisting of lithium lanthanum zirconium oxide, lithium carbon lanthanum zirconium oxide, and lithium lanthanum titanium oxide.

9. The method according to claim 1, wherein step (c) comprises evacuating pores of the at least one pellet and casting the liquid precursor on a surface of the at least one pellet.

10. The method according to claim 8, wherein step (d) comprises heating the at least one impregnated pellet at about 70-130° C. in ozone-rich, low humidity air followed by heating at about 280-350° C. in low humidity air.

11. The method according to claim 10, wherein the ozone-rich air contains at least about 0.05 ppm ozone.

12. The method according to claim 10, wherein the low humidity air has a relative humidity less than about 30%.

13. An impregnated solid state composite cathode comprising a sintered porous active intercalation material, wherein pores of the porous material are impregnated with an amorphous inorganic ionically conductive solid electrolyte.

14. The cathode according to claim 13, wherein the cathode is in a form of at least one pellet, a sheet, or a wafer.

15. The cathode according to claim 13, wherein the solid electrolyte comprises at least one material selected from the group consisting of lithium lanthanum zirconium oxide, lithium carbon lanthanum zirconium oxide, and lithium lanthanum titanium oxide.

16. The cathode according to claim 13, wherein the solid electrolyte is impregnated into the pores of the porous material as a liquid precursor solution and cured to form the solid electrolyte.

17. The cathode according to claim 13, wherein the cathode has a thickness of about 50 to 400 microns.

18. The cathode according to claim 13, produced by a method comprising:
(a) forming at least one pellet comprising an active intercalation cathode material;
(b) sintering the at least one pellet to form at least one sintered porous cathode pellet;
(c) impregnating pores of the at least one sintered porous cathode pellet with a liquid precursor of an inorganic amorphous ionically conductive solid electrolyte; and
(d) curing the at least one impregnated pellet to yield the composite electrode.

19. A solid state lithium battery comprising the cathode according to claim 13, a lithium-containing anode, and a solid separator.

20. An impregnated solid state composite electrode comprising a sintered porous active material, wherein pores of the porous material are impregnated with an amorphous inorganic ionically conductive solid electrolyte.

21. A solid state lithium battery comprising the electrode according to claim 20, a lithium-containing counter electrode, and a solid separator.

22. A method of producing an impregnated solid state composite electrode, comprising:
(a) forming at least one pellet comprising an active electrode material;
(b) sintering the at least one pellet to form at least one sintered porous electrode pellet;
(c) impregnating pores of the at least one sintered porous electrode pellet with a liquid precursor of an inorganic amorphous ionically conductive solid electrolyte; and
(d) curing the at least one impregnated pellet to yield the composite electrode.
